(19) United States
(12) Patent Application Publication
(10) Pub. No.: US 2023/0264324 A1
(43) Pub. Date: Aug. 24, 2023

(54) ADAPTABLE WRENCH

(71) Applicant: Stephen V. DUPHILY, Plaistow, NH (US)

(72) Inventor: Stephen V. DUPHILY, Plaistow, NH (US)

(21) Appl. No.: 18/173,974

(22) Filed: Feb. 24, 2023

Related U.S. Application Data
(60) Provisional application No. 63/268,454, filed on Feb. 24, 2022.

(51) Int. Cl. B25B 13/50; B25G 1/00; B25G 1/04; E03B 9/02

(52) U.S. Cl. CPC B25B 13/50; B25G 1/007; B25G 1/043; E03B 9/02

(57) ABSTRACT

Disclosed herein is an adaptable wrench. In some embodiments, a fire hydrant wrench is disclosed, comprising an elongated bar, at least a first handle and a second handle extending from one side of the elongated bar, and a socket positioned on an opposed sides of the elongated bar, wherein the socket is offset from the first handle and second handle. In some embodiments, a gate valve wrench is disclosed, comprising a socket positioned on an end of the gate valve wrench, the socket configured to mate with a gate valve boss, an extendable section mated to the socket, and a handle operatively coupled to the extendable section, the handle configured to be interchangeable between a first handle type and a second handle type. A method is disclosed for interchanging handles in an adaptable wrench.

### TECHNICAL FIELD

The present disclosure relates generally to the field of tools and more specifically to fire hydrant wrenches and gate valve wrenches.

### BACKGROUND

A wrench, or spanner, is a tool used to provide grip and mechanical advantage in applying torque to turn an object. A wrench may be used in opening and closing fire hydrant valves and/or gate valves.

A fire hydrant, or firecock, is a connection point by which firefighters can tap into a water supply. When tapping into the water supply, a user attaches a hose to the fire hydrant, then opens a fire hydrant valve on the hydrant to provide a powerful flow of water, on the order of 350 kPa (50 pounds per square inch gauge (psig); this pressure varies according to region and depends on various factors including the size and location of the attached water main).

A gate valve, also known as a sluice valve, is a valve that opens by lifting a barrier, or gate, out of the path of a fluid. Typically, gate valves are used to shut off the flow of liquids and are frequently used to control the flow of municipal water supplies. When fully open, the typical gate valve has no obstruction in the flow path, resulting in low flow resistance through the valve. At high pressures, friction can limit operation of a gate valve. As the gate is pushed against its guiding rail by the pressure of the medium, it can become harder to operate the valve. Some gate valves may be fitted with a bypass controlled by a smaller valve to be able to reduce the pressure before operating the gate valve itself.

### BRIEF DESCRIPTION OF THE FIGURES

The drawings described herein are for illustration purposes only and are not intended to limit the scope of the present disclosure in any way.

FIG. 1 illustrates a front side view of a wrench, in accordance with some embodiments of the disclosure.

FIG. 2 illustrates a cross-sectional plan view taken along line A-A of FIG. 1 of a wrench, in accordance with some embodiments of the disclosure.

FIG. 3 illustrates a front side view of a wrench, in accordance with some embodiments of the disclosure.

FIG. 4 illustrates a top view of a wrench, in accordance with some embodiments of the disclosure.

FIG. 5 illustrates a top front perspective view of a wrench, in accordance with some embodiments of the disclosure.

FIG. 6 illustrates a top rear perspective view of a wrench, in accordance with some embodiments of the disclosure.

FIG. 7 illustrates a rear side view of a wrench, in accordance with some embodiments of the disclosure.

FIG. 8 illustrates a bottom rear perspective view of a wrench, in accordance with some embodiments of the disclosure.

FIG. 9 illustrates a bottom view of a wrench, in accordance with some embodiments of the disclosure.

FIG. 10 illustrates a side view of a wrench, in accordance with some embodiments of the disclosure.

FIG. 11 illustrates a side view of a handle of a wrench, in accordance with some embodiments of the disclosure.

FIG. 12 illustrates a side view of a wrench, in accordance with some embodiments of the disclosure.

FIG. 13 illustrates a detail view of a handle of a wrench, in accordance with some embodiments of the disclosure.

FIG. 14 illustrates a detail view of a socket of a wrench, in accordance with some embodiments of the disclosure.

FIG. 15 illustrates a comparison of a T-bar handle and a crank handle of a wrench, in accordance with some embodiments of the disclosure.

### SUMMARY

In one aspect a fire hydrant wrench is provided, the wrench comprising an elongated bar, at least a first handle and a second handle extending perpendicularly from one side of the elongated bar, and a socket positioned on an opposed side of the elongated bar, wherein the socket is offset between the first handle and the second handle. The socket can comprise a pentagonal cutout configured to mate with a boss of a fire hydrant valve. The elongated bar can include a first segment between the first handle and the socket and a second segment between the second handle and the socket, wherein a length of the first segment is at least 1.5 times a length of the second segment. The ratio of the length of the first segment to the length of the second segment can be greater than 1.5:1, greater than 2:1, greater than 2.5:1, greater than 3:1, between 1.1:1 and 2:1, between 1.1:1 and 3:1 or between 1.5:1 and 3:1. The first handle and the second handle can be cylindrical in shape. The first handle and the second handle may be configured to rotate during operation. The bar can be hollow and rectangular in cross-section.

In another aspect, a method of opening or closing a fire hydrant valve is provided, the method including inserting a boss of a fire hydrant valve into a complementary socket or cutout on a wrench, rotating the wrench by grasping a first handle and applying a force to produce a first moment on the valve, further rotating the wrench by grasping a second handle opposed to the first handle and applying a second moment at the same force, the second moment less than or greater than the first moment, and opening the fire hydrant valve.

In another aspect a gate valve wrench is provided, the gate valve wrench comprising a socket connected to one end of an extendable section, the socket configured to mate with a gate valve boss, and a handle operatively coupled to the extendable section, the handle configured to be interchangeable between a first handle type and a second handle type. The first handle type can be a crank handle and the second handle type can be a T-bar handle. The crank handle can include a third crank arm configured at an angle of between 10° and 85° from a longitudinal axis of the extendable section. The extendable section can include a male portion and a female portion configured to slide over the male portion, wherein the male portion and the female portion comprise a set of aligned holes configured to receive a locking pin.

In another embodiment, a method for interchanging handles for a gate valve wrench is provided, the method comprising releasing a locking pin to release a first cap of a first handle from an extendable section of a gate valve wrench, wherein the locking pin is configured to secure a connection of the first cap of the first handle to the extendable section of the gate valve wrench, placing a second cap of a second handle on an end of the extendable section, and locking the second cap of the second handle to the extendable section using the locking pin.

### DETAILED DESCRIPTION

Embodiments are presented herein for an improved adaptable wrench. Some embodiments relate to a fire hydrant wrench. Some embodiments relate to a gate valve wrench. There is a need for an improved wrench system to provide improved torque transfer during actuation of the wrench system, to be more user friendly in allowing a user to maintain their hands in a single position while manipulating the wrench, and to allow for interchangeability with different handle types.

A socket on the adaptable wrench is configured to mate with a boss on a fire hydrant or on a gate valve. As used herein, a boss is defined as a protruding feature on a work piece that can mate with a wrench to provide the necessary torque to open or close the valve.

One example of the adaptable wrench as described herein is a fire hydrant wrench. In some embodiments, the fire hydrant wrench includes a lever with an off-center socket for mating with a boss of a fire hydrant valve. In some embodiments, the boss on a fire hydrant for attaching an adaptable wrench is a pentagonal boss. In some embodiments, the lever include two handles that are rotatable about their axis such that a user's hand can maintain a secure grip on the handle during operation. In other embodiments, handles are rotatably fixed to the lever shaft to which they are attached.

Another example of the adaptable wrench as described herein is a gate valve wrench. In some embodiments, gate valve wrench is configured with an extendable section. In some embodiments, the extendable section comprises fittings where a smaller male portion can be mated with a larger female portion. In some embodiments, the fittings are square tubes sized to mate securely to transfer torque. In some embodiments, the smaller male portion and larger female portion are round tubes. In some embodiments, each of the smaller male portion and the larger female portion are configured with a series of through holes that can receive a locking pin or bolt to secure the connection. These through holes allow the wrench to be extended to two, three, four or more distinct lengths that allow the same wrench to be used with gate valves at a variety of depths. The spacing between through holes can be, for example, 3 to 9 inches, 6 inches to 2 feet, or 1 to 3 feet. In some embodiments, the locking pin is a ⅜″ locking pin.

The extendable section is configured to lengthen the wrench from about 5 feet to about 11 feet, from about 6 feet to about 10.5 feet, from 6 feet 4 inches to 10 feet 4 inches, from 5 feet to 8 feet, or from 5 feet to 10 feet. In some embodiments, the gate valve wrench is configured with a square shaped socket. The square shaped socket is configured to mate with a square shaped boss on a gate valve. In some embodiments, the square shaped socket is 2.25 inches×2.25 inches, 2 inches×2 inches, 2.5 inches×2.5 inches, or 3 inches×3 inches.

In some embodiments, the gate valve wrench as described herein includes a speed crank handle. The gate valve wrench is configured to drive a gate valve socket. The speed crank handle may comprise a multi-segment handle. The speed crank handle may comprise a first crank arm, a second crank arm (or first spindle), a third crank arm, and a fourth crank arm (or second spindle). In some examples, the first crank arm, second crank arm, third crank arm, and fourth crank arm include a solid round steel bar or a square steel tube. In some embodiments, the fourth crank arm includes a threaded end configured to attach a handle. In some embodiments, the first crank arm, second crank arm, and third crank arm have a length of between 5 inches and 12 inches, between 6 inches and 18 inches, or between 5 inches and 7 inches, between 3 inches and 1 foot or between 3 inches and 24 inches. In some embodiments, the fourth crank arm has a length of between 0.5 inches and 2 inches, between 1 and 3 inches, or between 0.5 and 3 inches.

In some embodiments, the end of the fourth crank arm (second spindle) includes a first handle. In some embodiments, the second crank arm (first spindle) is configured with a second handle. The first handle, the second handle, or both may be a rotating handle. In some embodiments, a pipe may be configured around a circular rod to form a rotating handle.

In some embodiments, the crank handle of the gate valve wrench is configured to be swapped with a tap handle, T-bar handle, tee handle, or T-handle. A locking pin is used to set the length of the extendable section following extension or retraction. A locking pin facilitates attachment and detachment of the crank handle and/or the T-bar handle.

The adjustable wrench as described herein may be comprised of metal such as steel, stainless steel, or aluminum. Portions of the adjustable wrench may be forged, machined, extruded, or a combination thereof.

A method for interchanging handles in a gate valve wrench as disclosed herein comprises first releasing a locking pin to allow the release of a cap of a first handle. The locking pin is configured to mechanically join a connection of a cap of a handle to an extendable section of the gate valve wrench. Second, the method can include mating a cap of a second handle to an end of the extendable section. Third, the method can comprise securing the cap to the extendable section using a locking pin.

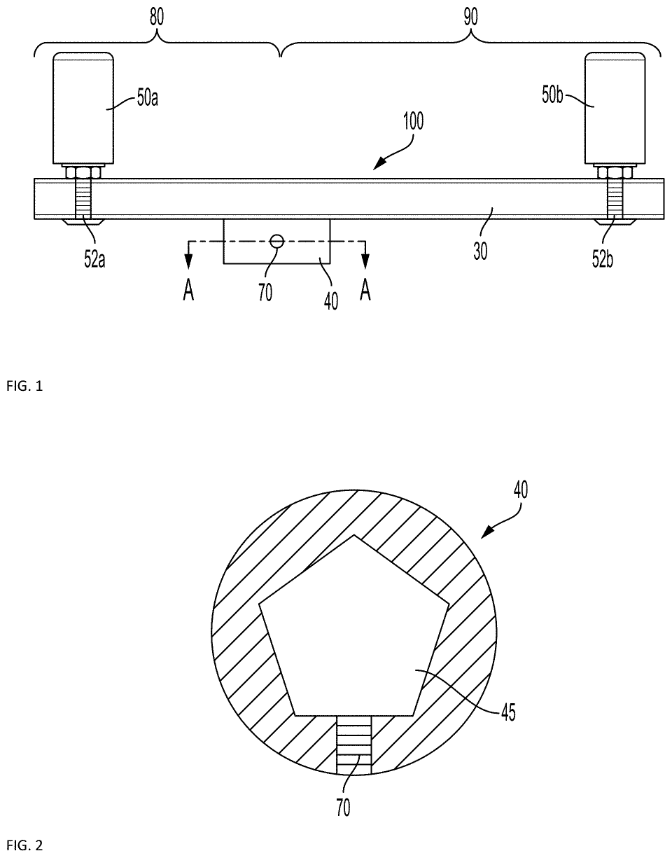

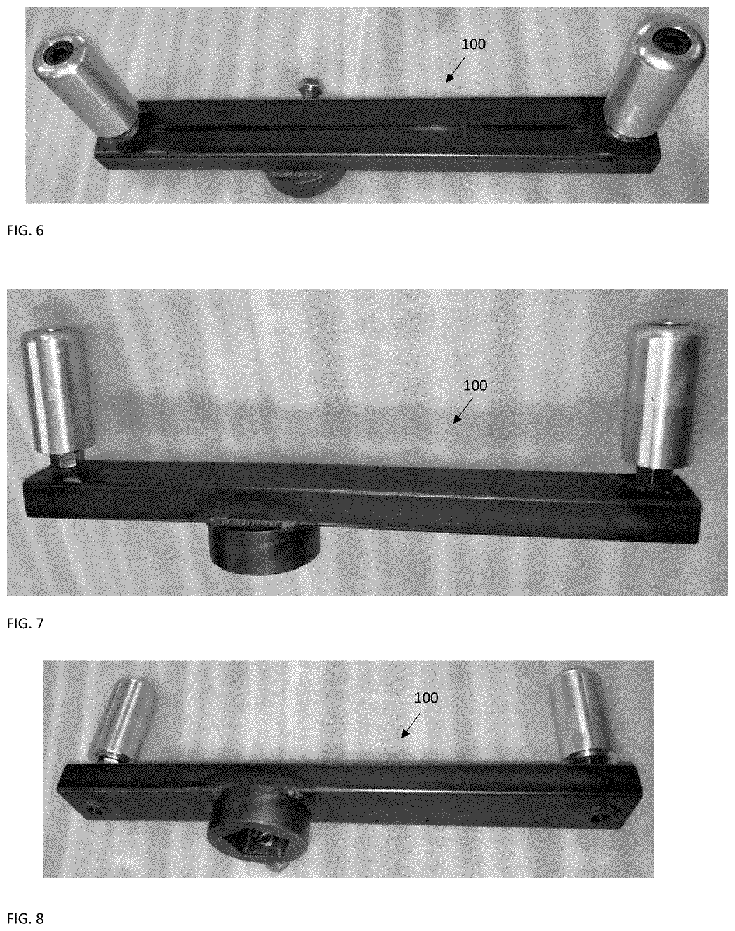

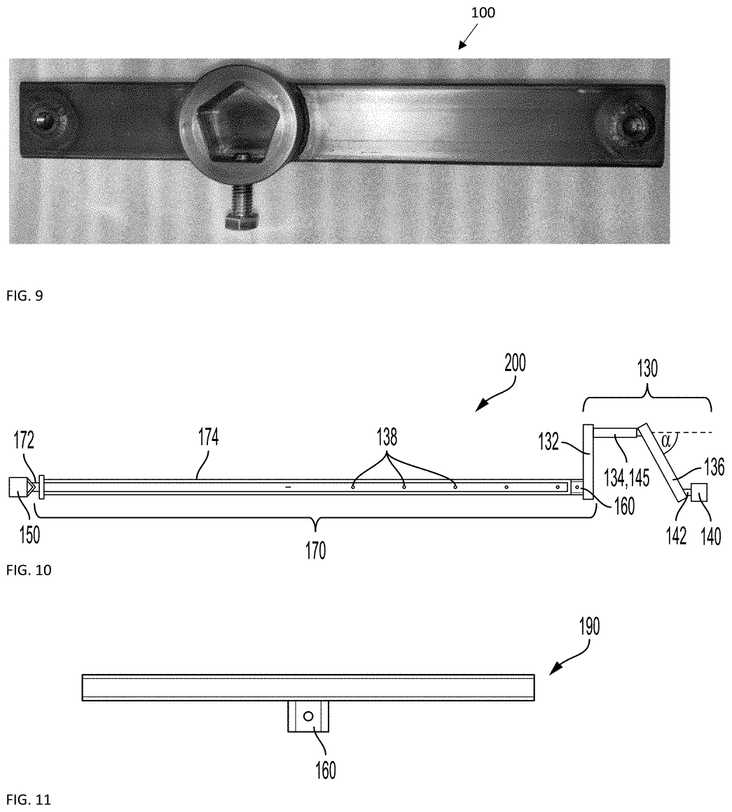

The components and operation of some embodiments of the adaptable wrench are presented in FIGS. 1-9, which may be configured for use as a fire hydrant wrench.

FIG. 1 provides a cross-sectional view of a fire hydrant wrench 100. Two handles 50a and 50b extend upward from bar 30 and are configured to be gripped, one at a time, by a user during operation. Threaded inserts 52a and 52b are configured under each handle, 50a and 50b, for rotatable attachment of each handle to bar 30. The threaded inserts may receive, for example, a bolt, post, bushing or screw to rotatably attach the handles to the bar. Socket 40 is positioned off-center on an underside of bar 30 so that it is not equidistant from each of handles 50a and 50b. In the illustrated embodiment of FIG. 1, first segment 80 is configured as a shorter segment and second segment 90 is configured as a longer segment. By using an offset socket 40, different moments can be applied to the valve by changing the handle that the user employs. For example, the handle closer to the socket will apply a smaller moment but provide faster rotation. The handle further from the socket will apply a greater moment (at the same force) but a slower rotation. Various configurations are contemplated for the positioning of socket 40 on the underside of bar 30. For example, the ratio of the length of segment 90 to the length of segment 80 can be greater than 1.5:1, greater than 2:1, greater than 2.5:1, greater than 3:1, between 1.1:1 and 2:1, between 1.1:1 and 3:1 or between 1.5:1 and 3:1. As shown, bar 30 is a hollow pipe that is rectangular (e.g., 1 inch by 2 inch) in cross-section. This provides for a relatively light wrench that possesses the strength to withstand the torque that may be applied. In other embodiments, bar 30 can be solid.

The off-center positioning of socket 40 provides two choices to rotate a fire hydrant valve depending on which handle 50 a user holds during use of fire hydrant wrench 100. Handle 50b will provide the most torque for a given force or weight and can be used to break the fire hydrant boss from its closed position and to loosen the valve when met with resistance. Handle 50a requires less travel of the user's hand and therefore can provide faster rotation, and opening, of the hydrant, resulting in faster delivery of water to the fire.

FIG. 2 illustrates a cross-sectional plan view taken along line A-A of FIG. 1. FIG. 2 highlights pentagonal cutout 45 which is configured to mate with a pentagonal boss of a fire hydrant valve. Threaded hole 70 is configured to receive a bolt 60 for securing socket 40 in a locked fit with a pentagonal boss of a fire hydrant valve. In other embodiments the pentagonal cutout can be cut directly through bar 30 so that no additional part needs to be connected to the bar. In these cases, the bar can be can be solid and can be, for example, more than 20%, more than 50% or more than twice as wide as the bar so that it remains structurally sound. The bar can include more than one socket or cutout so that it can be used on different size bosses. In one example, a first pentagonal boss can be made one third of the distance from handle 50a to 50b (see FIG. 1) and the second pentagonal cutout can be made one third of the distance from handle 50b to 50a. In this example, handle 50a would function as the low torque, fast turning handle for one of the cutouts and as the high torque, slower turning handle for the other. Multiple sockets or cutouts of the same or different sizes and geometries can be provided at different points along the bar 30. This can provide the user with options regarding how much torque and speed they choose to apply.

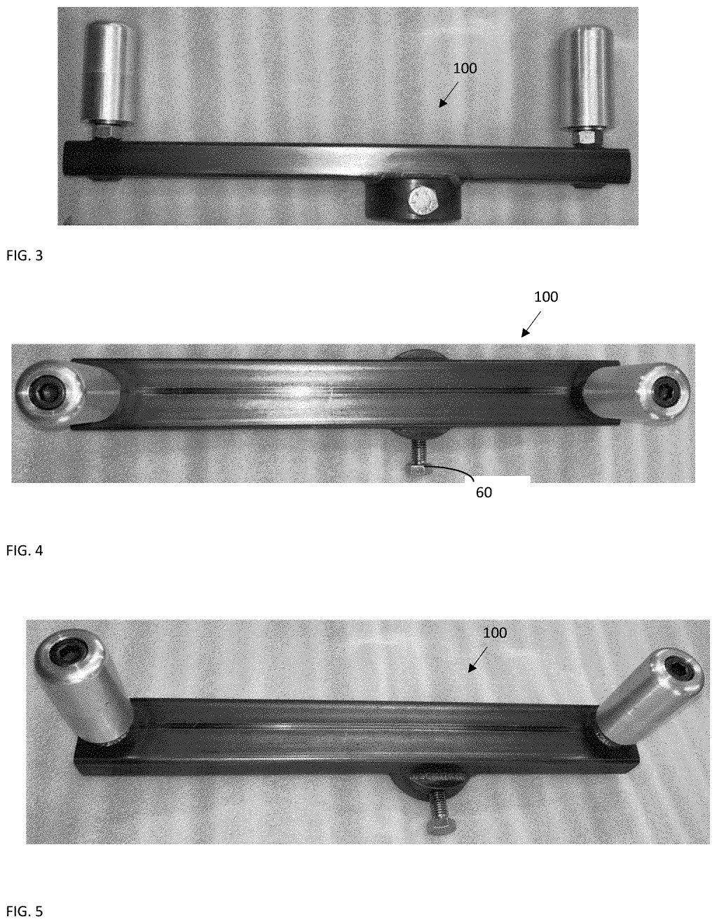

FIGS. 3-9 illustrate various views of the fire hydrant wrench 100.

The components and operation of some embodiments of the gate valve wrench are presented in FIGS. 10-15.

FIG. 10 provides a schematic illustration of gate valve wrench 200. As shown, gate valve wrench 200 includes socket 150, extendable section 170, and speed crank 130. Socket 150 is configured to mate with a boss on a gate valve. Extendable section 170 includes inner tube 172 and outer tube 174 to extend or contract a distance between speed crank 130 and socket 150 for ease of use. Speed crank 130 includes first crank arm 132 which extends perpendicular to the axis of extendable section 170. Crank 130 further includes spindle 134 which extends parallel to the length of extendable section 170. Crank 130 further includes third crank portion 136 which extends at an angle α from the longitudinal axis of the spindle 134. The third crank arm 136 is configured at an angle to clear the operator's arm and facilitate faster opening and/or closing of a gate valve. In some embodiments, angle α may be between 10° and 90°, between 25° and 90°, between 35° and 90°, between 30° and 80°, or between 50° and 85°. In the illustrated embodiment, speed crank 130 includes second handle 145 positioned on spindle 134. In some embodiments, second handle 145 is configured to rotate freely during operation. Crank 130 includes handle 140 attached to second spindle 142. In some embodiments, handle 140 is configured to rotate freely. Crank 130 is configured for two handed operation wherein a user can keep both hands positioned on crank 130 during initial loosening of the gate valve and as a user continues to turn crank 130 to complete opening of the gate valve. During rotation, section 170 can be kept substantially in the same axis as it rotates about that axis. Handle 145 is rotated in a circle around that axis while the user grips rotatable handle 140 with the other hand and retains handle 140 in essentially the same position during rotation of the wrench. Arms 132 and 136 can be dimensioned to allow comfortable, high torque use by one individual, as described above.

FIG. 11 illustrates T-bar handle 190. T-bar handle 190 can interchangeably be positioned on extendable section 170 using cap 160 secured with a locking pin 180 (shown in FIG. 13). T-bar handle can be extendable and can be used by one or two users. The T-bar handle can provide additional torque that can be particularly useful in breaking open a stuck valve.

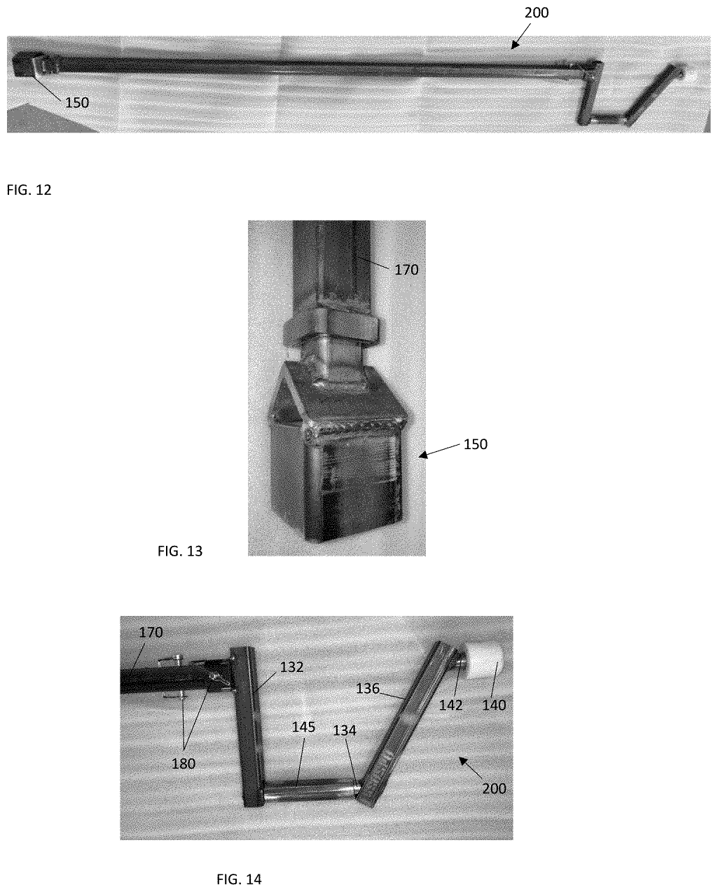

FIG. 12 illustrates a side view of a gate valve wrench wherein extendable section 170 is in a retracted position. FIG. 13 illustrates a detail view of square-shaped socket 150.

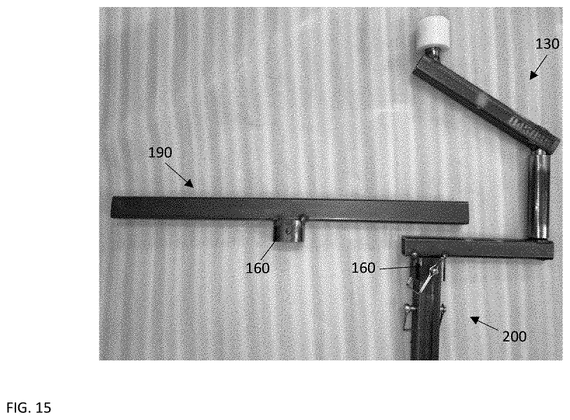

FIG. 14 illustrates a detail view of crank 130, including second handle 145 (a rotatable piece of steel pipe mounted on a bushing) surrounding spindle 134. FIG. 14 also highlights locking pin 180 being used to lock the extension of extendable section 170 as well as being used to lock cap 160 of crank 130 onto an end of extendable section 170. When locking pin 180 is released from cap 160, the crank handle can be interchanged with T-bar handle 190. FIG. 15 highlights each of crank handle 130 and T-bar handle 190.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A fire hydrant wrench, comprising:
an elongated bar;
at least a first handle and a second handle extending perpendicularly from one side of the elongated bar; and
a socket positioned on an opposed side of the elongated bar, or a cutout passing through the bar, wherein the socket or cutout is offset between the first handle and the second handle.

2. The fire hydrant wrench of claim 1, wherein the socket or cutout comprises a concave pentagonal structure configured to mate with a boss of a fire hydrant valve.

3. The fire hydrant wrench of claim 1, wherein the elongated bar comprises a first segment between the first handle and the socket and a second segment between the second handle and the socket, wherein a length of the first segment is at least 1.5 times a length of the second segment.

4. The fire hydrant wrench of claim 1 wherein the elongated bar comprises a first segment between the first handle and the socket and a second segment between the second handle and the socket and a ratio of the length of the first segment to the length of the second segment can be greater than 1.5:1, greater than 2:1, greater than 2.5:1, greater than 3:1, between 1.1:1 and 2:1, between 1.1:1 and 3:1 or between 1.5:1 and 3:1.

5. The fire hydrant wrench of claim 1, wherein the first handle and the second handle are cylindrical in shape.

6. The fire hydrant wrench of claim 4, wherein the first handle and the second handle are configured to rotate during operation.

7. The fire hydrant wrench of claim 1 wherein the bar is hollow and rectangular in cross-section.

8. A method of opening a fire hydrant comprising:
inserting a boss of a fire hydrant valve into a complementary socket or cutout on a wrench;
rotating the wrench by grasping a first handle and applying a force to produce a first moment on the valve;
further rotating the wrench by grasping a second handle opposed to the first handle and applying a second moment at the same force, the second moment less than the first moment; and
opening the fire hydrant valve.

9. A gate valve wrench comprising:
a socket connected to one end of an extendable section, the socket configured to mate with a gate valve boss; and
a handle operatively coupled to the extendable section, the handle configured to be interchangeable between a first handle type and a second handle type.

10. The gate valve wrench of claim 9, wherein the first handle type is a crank handle and the second handle type is a T-bar handle.

11. The gate valve wrench of claim 10, wherein the crank handle includes a third crank arm configured at an angle of between 10° and 85° from a longitudinal axis of the extendable section.

12. The gate valve wrench of claim 9, wherein the extendable section comprises a male portion and a female portion configured to slide over the male portion, wherein the male portion and the female portion comprise a set of aligned holes configured to receive a locking pin.

13. A method for interchanging handles in a gate valve wrench of claim 9, the method comprising:
releasing a locking pin to release a first cap of a first handle from an extendable section of a gate valve wrench, wherein the locking pin is configured to secure a connection of the first cap of the first handle to the extendable section of the gate valve wrench;
placing a second cap of a second handle on an end of the extendable section; and
locking the second cap of the second handle to the extendable section using the locking pin.
